(19) United States
(12) Patent Application Publication
(10) Pub. No.: US 2024/0313569 A1
(43) Pub. Date: Sep. 19, 2024

(54) ELECTRONIC APPARATUS OBTAINING ESTIMATED AMBIENT TEMPERATURE BASED ON CHARGING PROCESSING OF CHARGING UNIT, AND CONTROL METHOD

(71) Applicant: CANON KABUSHIKI KAISHA, Tokyo (JP)

(72) Inventor: RYUKI HASHIDA, Tokyo (JP)

(21) Appl. No.: 18/604,144

(22) Filed: Mar. 13, 2024

(30) Foreign Application Priority Data
Mar. 16, 2023 (JP) 2023-042318

(51) Int. Cl. H02J 7/00; G01K 3/00

(52) U.S. Cl. CPC H02J 7/007192; G01K 3/005; H02J 7/0047

(57) ABSTRACT

An electronic apparatus includes a first thermometer that detects a first temperature corresponding to an ambient temperature of an environment in which the electronic apparatus is used and a second thermometer that detects a second temperature corresponding to a temperature of an outer casing of the electronic apparatus. The electronic apparatus obtains an estimated ambient temperature using a first method when a charging processing has been executed in a state where the electronic apparatus is not activated, and obtains the estimated ambient temperature using a second method when the charging processing has not been executed in the state where the electronic apparatus is not activated.

### BACKGROUND

### Technical Field

One disclosed aspect of the embodiments relates to a technique to improve the accuracy of estimation of the ambient temperature in an electronic apparatus.

### Description of the Related Art

In an electronic apparatus such as a digital camera, with an increase in the load on image capture processing and image processing caused by, for example, an increase in the resolution of shot images, electronic devices (hereinafter, heat source devices) that comprise an image capturing unit, a control unit, and the like generate heat at the time of shooting, thereby raising the temperatures of the inside of a housing and an outer casing. For this reason, it is necessary to take measures, such as the International Electrotechnical Commission (IEC) 62368, to restrict operations of the electronic apparatus so as not to exceed a temperature at which operations of the heat source devices are guaranteed, and to restrict operations of the electronic apparatus in order to prevent an excessive increase in the temperature of the outer casing, which is touched directly by a user.

According to Japanese Patent No. 6703273, the ambient temperature is estimated using the temperatures detected in the vicinity of heat source devices, a reference temperature detected at a position that is distanced from the heat source devices, and a plurality of transfer functions.

However, when a housing is small, as in the case of a small electronic apparatus, the configuration of Japanese Patent No. 6703273 may lead to a case where there is no difference among the temperatures detected by a plurality of thermometers inside the housing, and a plurality of transfer functions cannot be prepared. Furthermore, as it is necessary to prepare as many thermometers as there are heat source devices, a problem also arises in which the number of components increases and the cost of the components rises.

Furthermore, in an electronic apparatus that has a function of charging a battery, the battery may be charged even while the power of the electronic apparatus is OFF. If the battery is charged while the power is OFF, there is a possibility that the temperature inside a housing rises due to heat generation of the battery. If the electronic apparatus is reactivated in a state where the heat inside the housing has not been sufficiently dissipated and the temperature inside the housing has not decreased to the ambient temperature, the configuration of Japanese Patent No. 6703273 causes the temperatures of the thermometers to become high under the influence of the temperature inside the housing, thereby making an estimated ambient temperature high as well.

### SUMMARY OF THE INVENTION

One aspect of the embodiments has been made in consideration of the aforementioned problems, and realizes techniques to improve the accuracy of estimation of the ambient temperature using a method that is simpler than conventional methods, thereby allowing an appropriate temperature to be set as an operation restriction temperature for an electronic apparatus.

In order to solve the aforementioned problems, the disclosed technique provides an electronic apparatus including a first thermometer, a second thermometer, a processor, and a memory. The first thermometer detects a first temperature corresponding to an ambient temperature of an environment in which the electronic apparatus is used. The second thermometer detects a second temperature corresponding to a temperature of an outer casing of the electronic apparatus. The memory stores a program that, when executed by the processor, cause the electronic apparatus to function as a charging unit and a control unit. The charging unit executes charging processing for charging a battery. The control unit performs control to obtain an estimated ambient temperature by estimating an ambient temperature based on the first temperature detected by the first thermometer, and restrict an operation of the electronic apparatus when the second temperature detected by the second thermometer has reached a threshold that has been set based on the estimated ambient temperature. The control unit obtains the estimated ambient temperature using a first method when the charging processing of the charging unit has been executed in a state where the electronic apparatus is not activated, and obtains the estimated ambient temperature using a second method when the charging processing of the charging unit has not been executed in the state where the electronic apparatus is not activated.

In order to solve the aforementioned problems, the technique provides a control method for an electronic apparatus, wherein the electronic apparatus comprises: a first thermometer that detects a first temperature corresponding to an ambient temperature of an environment in which the electronic apparatus is used; a second thermometer that detects a second temperature corresponding to a temperature of an outer casing of the electronic apparatus; and a charging unit that executes charging processing for charging a battery, wherein the control method comprises: performing control to obtain an estimated ambient temperature by estimating an ambient temperature based on the first temperature detected by the first thermometer, and restrict an operation of the electronic apparatus when the second temperature detected by the second thermometer has reached a threshold that has been set based on the estimated ambient temperature, in the controlling, the estimated ambient temperature is obtained using a first method when the charging processing of the charging unit has been executed in a state where the electronic apparatus is not activated, and the estimated ambient temperature is obtained using a second method when the charging processing of the charging unit has not been executed in the state where the electronic apparatus is not activated.

According to the disclosure, the accuracy of estimation of the ambient temperature is improved by using a method that is simpler than conventional methods, thereby allowing an appropriate temperature to be set as an operation restriction temperature for an electronic apparatus.

Further features of the disclosure will become apparent from the following description of exemplary embodiments (with reference to the attached drawings).

### BRIEF DESCRIPTION OF THE DRAWINGS

FIGS. 1A and 1B are external views of an electronic apparatus according to the present embodiment.

FIG. 2 is a block diagram showing a configuration of the electronic apparatus according to the present embodiment.

FIG. 3 is a flowchart showing control processing of the electronic apparatus according to the present embodiment.

FIGS. 4A and 4B are flowcharts showing control processing of the electronic apparatus according to the present embodiment.

FIG. 5 is a flowchart showing control processing of the electronic apparatus according to the present embodiment.

FIG. 6 is a flowchart showing control processing of the electronic apparatus according to the present embodiment.

### DESCRIPTION OF THE EMBODIMENTS

Hereinafter, favorable embodiments of the disclosure will be described in detail based on the attached drawings. Note that the embodiments described below are examples for realizing the disclosure; corrections or changes are to be made as appropriate depending on the configuration of an apparatus to which the present invention is applied and on various conditions, and the following embodiments are not intended to limit the disclosure. Furthermore, it is permissible to adopt a configuration in which parts of the embodiments described below are combined as appropriate.

In the present embodiment, an outer casing temperature and an ambient temperature are detected by temperature detection units that are placed on a housing of an electronic apparatus at positions distanced from each other, and control to restrict the operations of the electronic apparatus is executed when the outer casing temperature has reached an operation restriction temperature that has been set based on an estimated ambient temperature. Also, the electronic apparatus according to the present embodiment can be charged during a power-OFF; when the power of the electronic apparatus has been switched from OFF to ON, when the elapsed time period after the charging has been stopped is longer than a predetermined cooling time period with a charging time period during the power-OFF taken into consideration, it is determined that the inside of the housing has been sufficiently cooled and a detected temperature is set as an estimated ambient temperature, whereas when the elapsed time period after the charging has been stopped is shorter than the predetermined cooling time period, it is determined that the inside of the housing has not been sufficiently cooled and an estimated ambient temperature is calculated by correcting the detected temperature in accordance with the elapsed time period after the charging has been stopped. In this way, the accuracy of estimation of the ambient temperature can be improved using a method that is simpler than conventional methods, and an appropriate temperature can be set as the operation restriction temperature of the electronic apparatus.

The following embodiment will be described in relation to a case where an electronic apparatus of the disclosure is an image capture apparatus such as a digital camera. Note that the electronic apparatus of the disclosure is not limited to the digital camera, and an application to a handheld apparatus including a device that acts as a heat source—such as a personal computer (PC) (e.g., a notebook PC, a tablet PC) and a smartphone—is possible.

### <Apparatus Configuration>

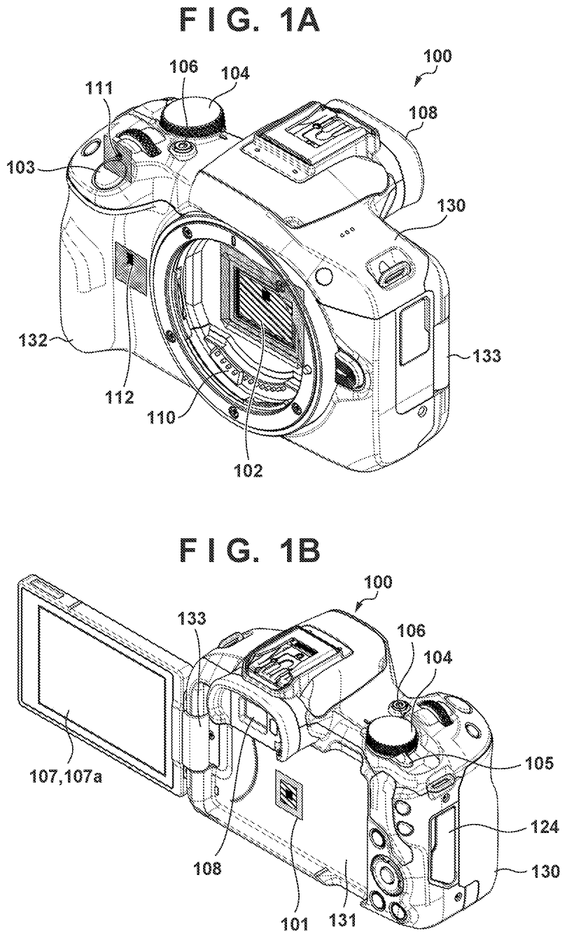

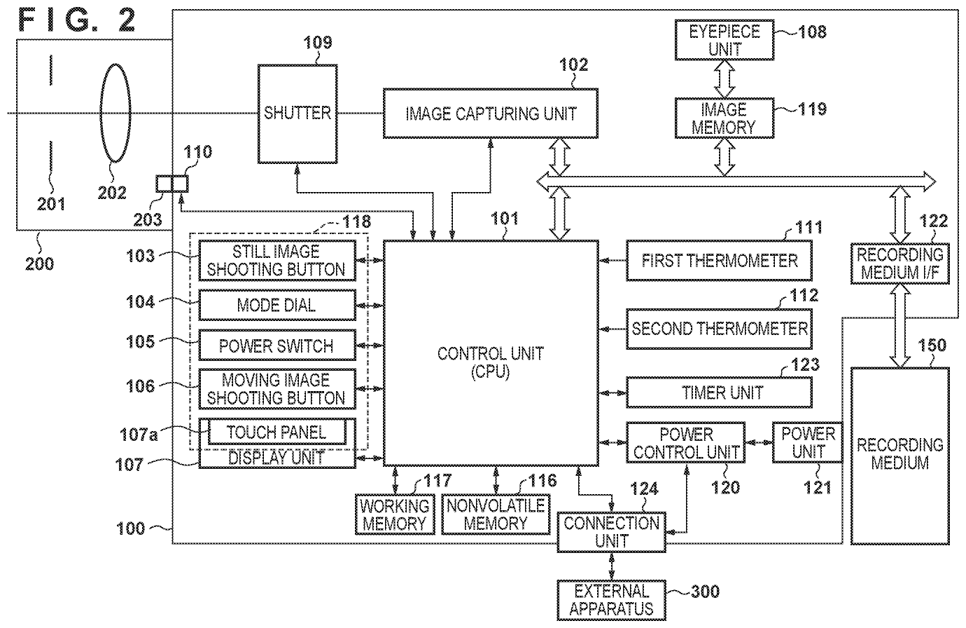

A description is now given of a configuration and functions of a digital camera 100 according to the present embodiment with reference to FIG. 1A to FIG. 2.

FIG. 1A is a front perspective view of the digital camera 100 in a state where a lens unit 200 has been detached, and FIG. 1B is a rear perspective view of the digital camera 100.

The digital camera 100 includes a control unit 101 and an image capturing unit 102 that are mounted on a substrate arranged inside a housing of a camera body 130, and a still image shooting button 103, a mode dial 104, a power switch 105, a moving image shooting button 106, a display unit 107, and an eyepiece unit 108 that are arranged on an outer casing of the camera body 130. Also, the digital camera 100 includes a first thermometer 111 and a second thermometer 112.

The control unit 101 includes a processor that executes computation processing and control processing related to the digital camera 100, such as a central processing unit (CPU). The image capturing unit 102 is an image sensor comprised of an image capture element that converts a subject image into electrical signals, such as a charge coupled device (CCD) and a complementary metal oxide semiconductor (CMOS) device.

The still image shooting button 103 is a push-button operation member for issuing an instruction for still image shooting processing to the control unit 101.

The mode dial 104 is a rotary operation member for switching among various types of modes. The mode dial 104 can switch from a plurality of operation modes of the control unit 101 to a still image shooting mode or a moving image shooting mode

The power switch 105 is a rotary operation member that switches between ON and OFF of the power of the digital camera 100.

The moving image shooting button 106 is a push-button operation member for issuing an instruction for starting or stopping moving image shooting processing (recording processing) to the control unit 101. The control unit 101 starts the moving image shooting processing in response to pressing of the moving image shooting button 106 during the suspension of moving image shooting, and continues the moving image shooting processing until the moving image shooting button 106 is pressed again. Also, the control unit 101 stops the moving image shooting processing when the moving image shooting button 106 has been pressed again, and records moving images corresponding to a time period from the start to the stop of the shooting processing into a recording medium 150.

The display unit 107 includes, for example, a liquid crystal panel or an organic EL panel provided on the rear surface side of the camera body 130, and displays images and various types of information so that they can be viewed by a user. The display unit 107 has an electronic viewfinder (EVF) function that displays live-view images captured by the image capturing unit 102. Furthermore, the display unit 107 has an electronic viewfinder (EVF) function that reproduces shot still images and displays moving images that are currently recorded. The display unit 107 is a vari-angle monitor which is rotatably connected to the camera body 130 via a hinge unit 133, and which is positionally variable relative to the camera body 130. The user can freely change the direction and angle of, or rotate, a display surface of the vari-angle monitor relative to the digital camera 100. Note that the display unit 107 is not limited to the above-described vari-angle type, and may be of a tilt type which allows rotation in an up-down direction (around a horizontal axis perpendicular to an optical axis) using the hinge unit 133 as a rotation shaft, and which allows the display surface to tilt relative to a vertical direction.

FIG. 1A shows a state where the display unit 107 is at a “closed position”. The “closed position” is a stored form where the display surface of the display unit 107 has been closed so as to face a rear surface cover 131 of the camera body 130. FIG. 1B shows a state where the display unit 107 is at an “open position”. The “open position” is an open form where the display unit 107 has been opened toward the outside of the camera body 130 from the “closed position”, and the display surface faces the same direction as the rear surface cover 131 of the camera body 130 (a direction opposite to the non-illustrated lens unit).

Furthermore, the display unit 107 includes a touch panel 107a. The touch panel 107a includes a touch sensor capable of detecting a contact (a touch operation) made on the display surface of the display unit 107 (an operation surface of the touch panel 107a).

The eyepiece unit 108 is a look-through type eyepiece viewfinder. Via the eyepiece unit 108, the user can confirm the focus and composition of a subject in an image captured by the image capturing unit 102.

A communication terminal 110 is an electrical contact point that allows the digital camera 100 to communicate with the non-illustrated lens unit. A connection unit 124 is a connector for connecting an external device such as a charger to the digital camera 100 and is provided on the side surface of the camera body 130. FIG. 1B shows a state in which the connection 124 is covered by a cover, and the connection unit 124 is constituted so as to be exposed on the side surface of the camera body 130 by opening the cover.

The first thermometer 111 includes a temperature sensor such as a thermistor. The first thermometer 111 detects a first temperature T1 for obtaining the ambient temperature, which corresponds to the temperature of the environment in which the camera body 130 is used. The first thermometer 111 is arranged at a position that is distanced from the control unit 101 and the image capturing unit 102 by a predetermined distance (e.g., in the vicinity of the still image shooting button 103). The control unit 101 and the image capturing unit 102 are arranged inside the housing of the camera body 130. The control unit 101 and the image capturing unit 102 are devices that generate heat as a result of the digital camera 100 operating in the power ON state (hereinafter, heat source devices). The first thermometer 111 is arranged at a position that is distanced from these heat source devices by a predetermined distance.

The second thermometer 112 includes a temperature sensor such as a thermistor. The second thermometer 112 detects a second temperature T2, which corresponds to an outer casing temperature of the camera body 130. The second thermometer 112 is placed so that the temperature detected by the second thermometer 112 has a correlation with the temperature of a position that exhibits the highest temperature due to heat generation of the heat source devices out of a section in which the user touches the camera body 130 to hold the digital camera 100. In the present embodiment, the second thermometer 112 is arranged in the vicinity of a grip 132, for example.

Next, with reference to FIG. 2, internal configurations of the digital camera 100 and the lens unit 200 according to the present embodiment will be described. In FIG. 2, configurations that are the same as those in FIGS. 1A and 1B are given the same reference signs.

The lens unit 200 includes a diaphragm 201 and a shooting lens 202, and is attachable to and detachable from the digital camera 100. The shooting lens 202, though normally comprised of a plurality of lenses, is illustrated here as only one lens for the sake of simplicity.

A communication terminal 203 is an electrical contact point that allows the lens unit 200 to communicate with the digital camera 100. The communication terminal 203 of the lens unit 200 is electrically connected to the communication terminal 110 of the digital camera 100 in a state where the lens unit 200 is attached to the camera body 130 of the digital camera 100. The control unit 101 of the digital camera 100 controls the diaphragm 201 and the shooting lens 202 by communicating with the lens unit 200 via the communication terminals 110 and 203.

The control unit 101 includes a processing circuit having at least one processor and at least one circuit and realizes each of the functions of the digital camera 100, including each type of processing of a later-described flowchart, by executing a program stored in a nonvolatile memory 116 to cause the digital camera 100 to function as functional units described in the following. A working memory 117 is a RAM or the like; constants and variables for the operations of the control unit 101, the program that has been read out from the nonvolatile memory 116, and the like are loaded thereto.

A focal-plane shutter 109 is capable of freely controlling an exposure time period of the image capturing unit 102 in accordance with an instruction from the control unit 101.

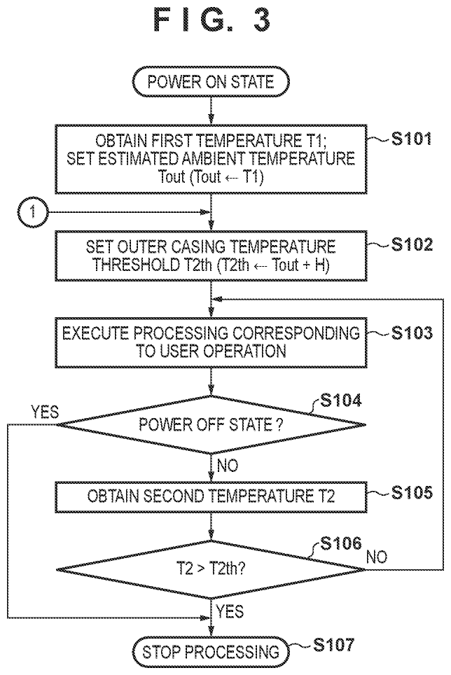

The nonvolatile memory 116 is an electrically erasable and recordable EEPROM or the like, for example. Constants for the operations of the control unit 101, the program, and the like are stored in the nonvolatile memory 116. The program according to the present embodiment refers to a program for executing the flowchart that will be described later using FIGS. 3 to 6.

Also, the control unit 101 executes predetermined pixel interpolation, resize processing such as reduction, and color conversion processing with respect to image data captured by the image capturing unit 102. Furthermore, the control unit 101 executes computation processing using image data captured by the image capturing unit 102, and performs automatic exposure (AE) control and autofocus (AF) control based on the result of the computation.

In the still image shooting mode, the control unit 101 starts the AE control and the AF control when the still image shooting button 103 has been pressed halfway. Also, the control unit 101 executes still image shooting processing in which image data captured by the image capturing unit 102 is recorded into the recording medium 150 when the still image shooting button 103 has been fully pressed.

Furthermore, in the moving image shooting mode, the control unit 101 starts moving image shooting processing in response to initial pressing of the moving image shooting button 106 during the suspension of moving image shooting. Once the moving image shooting processing has been started, the control unit 101 performs the AE control and the AF control with respect to moving image data captured by the image capturing unit 102, continues the moving image shooting processing in which moving images are recorded into the recording medium 150, and stops the moving image shooting processing when the moving image shooting button 106 has been pressed again.

An operation unit 118 represents operation members, such as various types of switches and buttons, that accept various types of operations from the user and provide notifications to the control unit 101. The operation unit 118 includes at least the still image shooting button 103, the mode dial 104, the power switch 105, the moving image shooting button 106, and the touch panel 107a.

An image memory 119 stores image data captured by the image capturing unit 102 and data for image display, which is to be displayed on the display unit 107 or the eyepiece unit 108. The image memory 119 has a storage capacity that is sufficient to store a predetermined number of still images, and moving images and audio of a predetermined time period.

A power control unit 120 is comprised of, for example, a battery detection circuit, a DC-DC converter, and a switch circuit for switching a block to which current is supplied, and detects whether a battery has been loaded, a type of the battery, and a remaining battery level. The power control unit 120 also controls the DC-DC converter based on the results of such detections and on an instruction from the control unit 101 so as to supply necessary voltages to the respective components, including the recording medium 150, for a necessary time period.

A power unit 121 is used as a power source for the digital camera 100, and is comprised of a primary battery such as an alkaline battery and a lithium battery, a chargeable secondary battery such as a NiCd battery, a NiMH battery, and a Li-ion battery, or the like. A recording medium I/F 122 is an interface with the recording medium 150, which is a memory card, a hard disk, or the like. The recording medium 150 is a recording medium, such as a memory card, for recording still images or moving images in the still image shooting processing or the moving image shooting processing, and is comprised of a semiconductor memory, a magnetic disk, or the like.

A timer unit 123 includes a real-time clock (RTC), and generates time information in response to a request from the control unit 101. In the present embodiment, time information includes information related to a date and time.

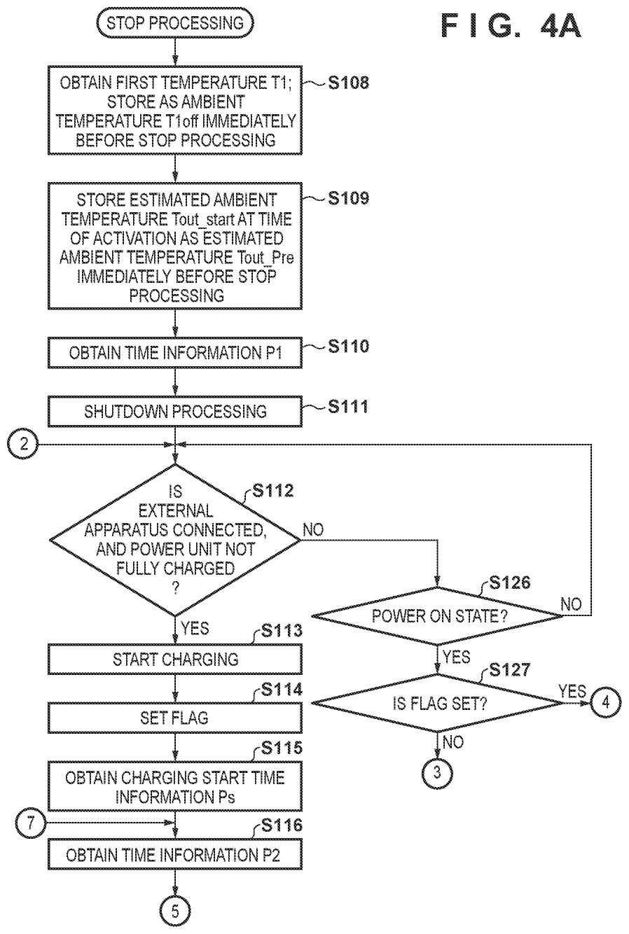

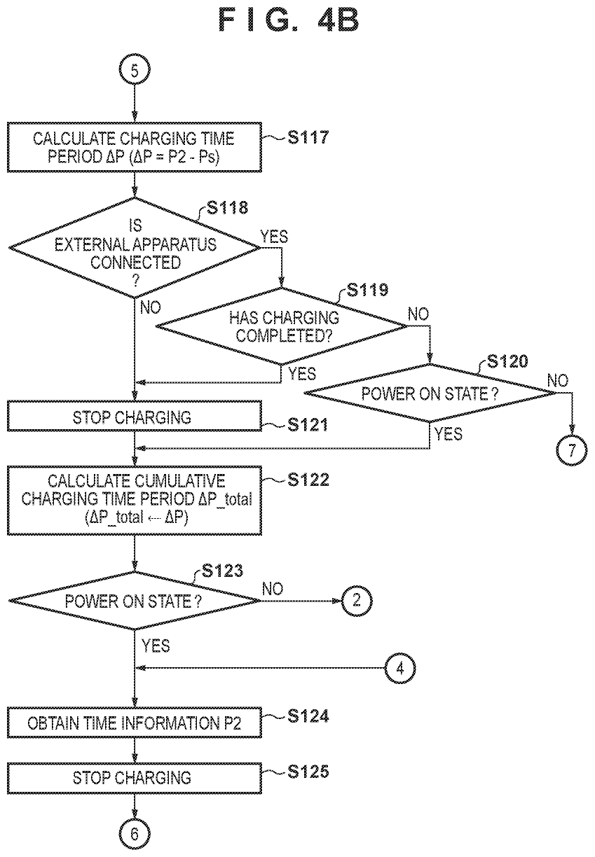

The connection unit 124 is an interface which is intended to connect the digital camera 100 to an external apparatus 300, and which conforms with, for example, the USB Power Delivery (USB PD) standard. The connection unit 124 can perform data communication and exchange power with the external apparatus 300, which conforms with the USB PD standard. The external apparatus 300 is, for example, a charger that uses a commercial power source or a battery as a power source, and supplies power to the digital camera 100 via the connection unit 124. The power control unit 120 can charge the power unit 121 using power that is supplied from the external apparatus 300 via the connection unit 124, even when the digital camera 100 is in a power-OFF state (a deactivated state, hereinafter a shutdown state). Therefore, the power control unit 120 charges the battery of the power unit 121 using power from the charger connected to the connection unit 124 in the power-OFF state. The power unit 121 generates heat while being charged by the power control unit 120. Therefore, the power unit 121 acts as a heat source device in the shutdown state. The control unit 101 can execute control processing, which will be described later using FIGS. 4A to 6, when the digital camera 100 is in the power-OFF state. Note that the shutdown state of the digital camera 100 includes, for example, a state where the power of the digital camera 100 is OFF (auto power-OFF) as a result of detection of an instruction for power-OFF by the power switch 105, or a state where no operation has been performed for a predetermined time period. Furthermore, the power-OFF state includes a state where the power supply to the heat source devices has been stopped due to a restriction of operations based on the outer casing temperature as will be described later.

### <Control Processing>

Next, control processing according to the present embodiment will be described with reference to FIG. 3.

FIG. 3 is a flowchart showing the control processing of the digital camera 100 according to the present embodiment.

Processing of FIG. 3 begins when activation processing has been started as a result of the control unit 101 detecting that the power switch 105 has been operated by a user for switching the digital camera 100 from power OFF state to power ON state. Note, it is assumed that, until processing of FIG. 3 is started, the temperature inside the housing of the camera body 130 is the same as the actual ambient temperature TO, which is the real ambient temperature, and the first temperature T1 detected by the first thermometer 111 is also the same as the actual ambient temperature TO.

In processing of FIG. 3, processing for restricting the operations of the digital camera 100 based on the estimated ambient temperature Tout of the digital camera 100 and on the second temperature T2, which represents the outer casing temperature of the camera body 130, is executed.

In step S101, the control unit 101 obtains the first temperature T1 from the first thermometer 111, and stores the same into the nonvolatile memory 116 as an estimated ambient temperature Tout_start at the time of activation in the environment in which the camera body 130 is used.

In step S102, the control unit 101 calculates an outer casing temperature threshold T2th based on the estimated ambient temperature Tout_start at the time of activation, which has been obtained in step S101, and stores the same into the nonvolatile memory 116. The control unit 101 calculates the outer casing temperature threshold T2th by adding a constant H to the estimated ambient temperature Tout_start at the time of activation, which has been obtained in step S101. As will be described later, the outer casing temperature threshold T2th is used as a threshold when the operations of the digital camera 100 are restricted based on the outer casing temperature of the camera body 130. The outer casing temperature threshold T2th is set in consideration of the influence on a user who is using the digital camera 100. The constant H is obtained in advance through an experiment or the like; for example, when the estimated ambient temperature Tout is 20° C., the constant His 23° C.

In step S103, the control unit 101 controls the digital camera 100 in accordance with a user operation. For example, after the power is turned ON, the control unit 101 places the digital camera 100 in a shooting standby state. Also, the control unit 101 executes the still image shooting processing when the user has operated the still image shooting button 103, and executes the moving image shooting processing when the user has operated the moving image shooting button 106. In addition, the digital camera 100 may also execute processing other than shooting processing.

In step S104, the control unit 101 determines whether the user has issued an instruction for turning the power OFF. When the control unit 101 has determined that the instruction for turning the power OFF has not been issued, control of the digital camera 100 is continued as is, and the control unit 101 proceeds the processing to step S105. When the control unit 101 has determined that the instruction for turning the power OFF has been issued, the control unit 101 proceeds the processing to step S107, and stop processing for turning OFF the power of the digital camera 100 is executed. In the absence of detection of the OFF-state of the power switch 105, or in the absence of detection of a state where no operation has been performed for a predetermined time period, the control unit 101 determines that control corresponding to a user instruction, such as shooting processing, is to be continued. When the instruction for power-OFF has been issued by the power switch 105 in step S104, or when a state where no operation has been performed for a predetermined time period has been detected, the control unit 101 executes the stop processing for making a transition to the shutdown state in step S107.

In step S105, the control unit 101 obtains the second temperature T2 from the second thermometer 112, and stores the same into the working memory 117 as the outer casing temperature.

In step S106, the control unit 101 compares the second temperature T2 obtained in step S105 with the outer casing temperature threshold T2th calculated in step S102 and determines whether the second temperature T2 is higher than the outer casing temperature threshold T2th. When the control unit 101 has determined that the outer casing temperature T2 obtained in step S106 is not higher than the outer casing temperature threshold T2th calculated in step S102, the control unit 101 returns the processing to step S104, and control of shooting processing or the like is continued. When the control unit 101 has determined that the outer casing temperature T2 obtained in step S106 is higher than the outer casing temperature threshold T2th calculated in step S102, the control unit 101 proceeds the processing to step S107.

In step S107, the control unit 101 stops control of shooting processing or the like in order to restrict the operations of the digital camera 100, and executes the stop processing for making a transition to the shutdown state. In this case, notifying the user of an operable time period of the digital camera 100 until the second temperature T2, which is the outer casing temperature of the digital camera 100, reaches the outer casing temperature threshold T2th enables the user to confirm a shootable time period in a shooting mode, for example.

FIGS. 4A and 4B are flowcharts showing the control processing executed in the stop processing of step S107 of FIG. 3.

In step S108, the control unit 101 obtains the first temperature T1 from the first thermometer 111, and stores the same into the nonvolatile memory 116 as an ambient temperature T1off immediately before the stop processing. The ambient temperature T1off immediately before the stop processing is used to calculate an estimated ambient temperature Tout at the time of reactivation of the digital camera 100 (steps S204 and S206).

In step S109, the control unit 101 stores the estimated ambient temperature Tout_start at the time of activation, which has been obtained in step S101 of FIG. 3, into the nonvolatile memory 116 as an estimated ambient temperature Tout_pre immediately before the stop processing. The estimated ambient temperature Tout_pre immediately before the stop processing is used to calculate the estimated ambient temperature Tout at the time of reactivation of the digital camera 100 (steps S205 and S206).

In step S110, the control unit 101 obtains current time information P1 from the timer unit 123, and stores the same into the nonvolatile memory 116. The current time information P1 is used to calculate a time period that has elapsed since the stop processing of the digital camera 100 until reactivation thereof.

In step S111, the control unit 101 executes shutdown processing for the digital camera 100. Here, the control unit 101 stops a power supply to the image capturing unit 102 and the display unit 107, for example.

In step S112, the control unit 101 determines whether the external apparatus 300 is connected to the connection unit 124 and the power unit 121 is in a fully charged state. When the control unit 101 has determined that the external apparatus 300 is connected to the connection unit 124 and the power unit 121 is in a fully charged state, the control unit 101 proceeds the processing to step S113. When the control unit 101 has determined that the external apparatus is not connected to the connection unit 124 or the power unit 121 is in a fully charged state, the control unit 101 proceeds the processing to step S126.

In step S113, with use of the power control unit 120, the control unit 101 executes charging processing for the power unit 121 using power that is supplied from the external apparatus 300 via the connection unit 124.

In step S114, the control unit 101 sets a charging execution flag F indicating that the charging processing has been executed, and stores the same into the working memory 117.

In step S115, the control unit 101 obtains current time information from the timer unit 123, and stores the same into the working memory 117 as charging start time information Ps.

In step S116, the control unit 101 obtains current time information P2 from the timer unit 123, and stores the same into the working memory 117. The time information P2 is used to calculate the length of a time period for which the power control unit 120 charged the power unit 121 (a charging time period).

In step S117, the control unit 101 calculates the difference between the time information P2 obtained in step S116 and the charging start time information Ps (P2−Ps), and stores the same into the working memory 117 as a charging time period ΔP.

In steps S118, S119, and S120, the control unit 101 determines whether to continue the charging processing started in step S113.

In step S118, the control unit 101 determines whether the external apparatus 300 is connected to the connection unit 124. When the control unit 101 has determined that the external apparatus 300 is connected to the connection unit 124, the control unit 101 proceeds the processing to step S119. When the control unit 101 has determined that the external apparatus 300 is not connected to the connection unit 124, the control unit 101 proceeds the processing to step S121.

In step S119, the control unit 101 determines whether the charging processing has been completed. When the power unit 121 has become a fully charged state, the charging processing of the power unit 121 has been completed. When the control unit 101 has determined that the charging processing has been completed, the control unit 101 proceeds the processing to step S119. When the control unit 101 has determined that the charging processing has not been completed, the control unit 101 proceeds the processing to step S120.

In step S120, the control unit 101 determines whether the power switch 105 has been operated for switching the digital camera 100 from power OFF state to power ON state. When the control unit 101 has determined that the power switch 105 has been operated for switching the digital camera 100 from power OFF state to power ON state, the control unit 101 proceeds the processing to step S122. When the control unit 101 has determined that the power switch 105 has not been operated for switching the digital camera 100 from power OFF state to power ON state, the control unit 101 returns the processing to step S116, and the calculation of the charging time period ΔP is continued.

In step S121, the control unit 101 stops the charging processing executed by the power control unit 120.

In step S122, the control unit 101 stores the charging time period ΔP calculated in step S117 into the nonvolatile memory 116 as a cumulative charging time period ΔP_total after the start of charging in step S113.

In step S123, the control unit 101 determines whether the power switch 105 has been operated for switching the digital camera 100 from power OFF state to power ON state. When the control unit 101 has determined that the power switch 105 has been switched from OFF to ON, the control unit 101 proceeds the processing to step S124. When the control unit 101 has determined that the power switch 105 has not been switched from OFF to ON, the control unit 101 returns the processing to step S112, and processing in the shutdown state is continued. In a case where the control unit 101 has determined that the power switch 105 has been operated for switching the digital camera 100 from power OFF state to power ON state in step S120 or in step S127 (described later) and the digital camera 100 has become power ON state, the control unit 101 determines YES in step S123.

In step S124, the control unit 101 obtains current time information P2 from the timer unit 123, and stores the same into the nonvolatile memory 116. The time information P2 is used to calculate an elapsed time period ΔP2 after the charging has been stopped.

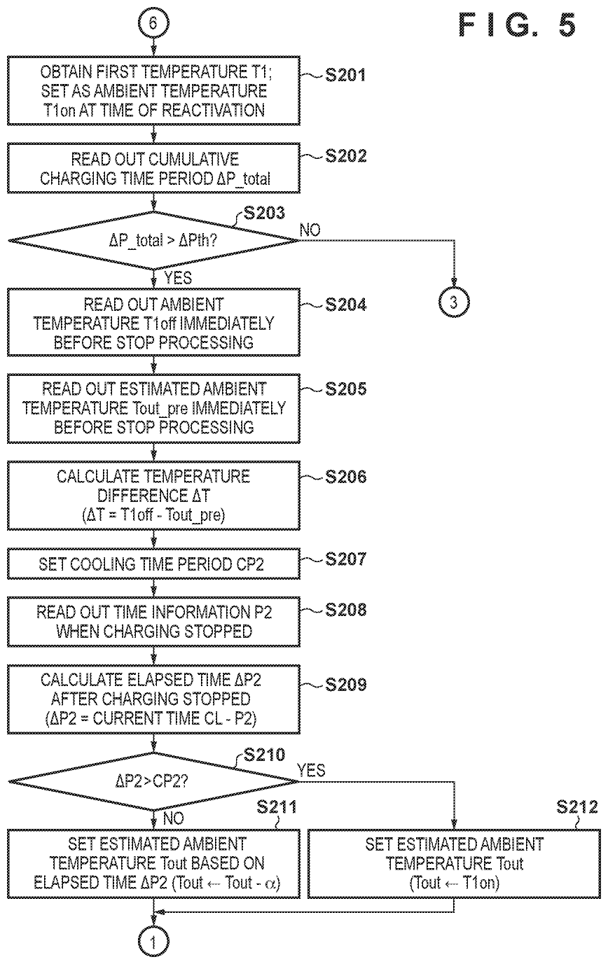

In step S125, the control unit 101 stops the charging processing executed by the power control unit 120, and the control unit 101 proceeds the processing to step S201 of FIG. 5.

In step S126, the control unit 101 determines whether the power switch 105 has been operated for switching the digital camera 100 from power OFF state to power ON state. When the control unit 101 has determined that the power switch 105 has been operated for switching the digital camera 100 from power OFF state to power ON state, the control unit 101 proceeds the processing to step S127. When the control unit 101 has determined that the power switch 105 has not been operated for switching the digital camera 100 from power OFF state to power ON state, the control unit 101 returns the processing to step S112, and processing in the shutdown state is continued.

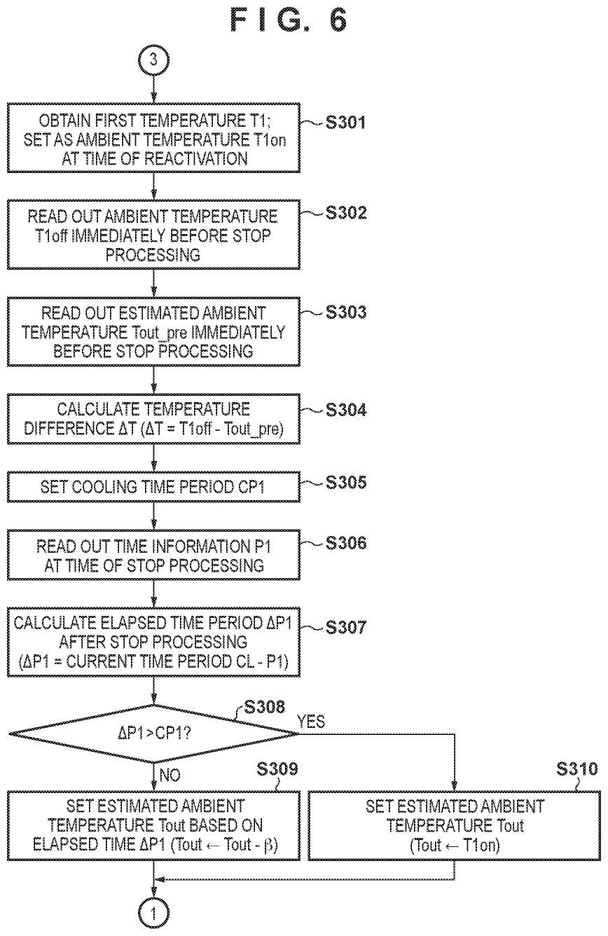

In step S127, the control unit 101 determines whether the charging execution flag F has been set. When the control unit 101 has determined that the flag F has been set, the control unit 101 proceeds the processing to step S124. When the control unit 101 has determined that the flag F has not been set, the control unit 101 proceeds the processing to step S301 of FIG. 6.

FIG. 5 is a flowchart showing the control processing for a case where the charging processing has been executed in the shutdown state, the charging processing has been stopped after the power has been switched from OFF to ON, and the digital camera 100 has been activated.

In step S201, the control unit 101 obtains the first temperature T1 from the first thermometer 111, and stores the same into the working memory 117 as an interim ambient temperature T1on at the time of reactivation.

In step S202, the control unit 101 reads out the cumulative charging time period ΔP_total obtained in step S122 from the nonvolatile memory 116.

In step S203, the control unit 101 determines whether the cumulative charging time period ΔP_total obtained in step S202 is greater than a threshold ΔP_th. The threshold ΔP_th is set at the time at which the power unit 121 generates heat due to the charging processing. When the control unit 101 has determined that the cumulative charging time period ΔP_total is greater than the threshold ΔP_th, the control unit 101 proceeds the processing to step S204. When the control unit 101 has determined that the cumulative charging time period ΔP_total is not greater than the threshold ΔP_th, the control unit 101 proceeds the processing to step S301 of FIG. 6.

In step S204, the control unit 101 reads out the ambient temperature T1off immediately before the stop processing, which has been obtained in step S108 of FIG. 4A, from the nonvolatile memory 116.

In step S205, the control unit 101 reads out the estimated ambient temperature Tout_pre immediately before the stop processing, which has been obtained in step S109 of FIG. 4A, from the nonvolatile memory 116.

In step S206, the control unit 101 calculates a temperature difference ΔT between T1off and Tout_pre obtained in steps S204 and S205 (T1off−Tout_pre), and stores the same into the working memory 117.

In step S207, in accordance with the temperature difference ΔT calculated in step S206, the control unit 101 sets a cooling time period CP2 until the temperature inside the camera body 130 decreases to the actual ambient temperature TO, which is the real ambient temperature, and stores the same into the working memory 117. Even when the digital camera 100 has been placed in the shutdown state, the temperatures of the heat source devices that were operating until immediately before the shutdown do not immediately start to decrease, and the heat source devices continue to generate heat for a while. Also, in a case where the power unit 121 is charged in the shutdown state as in the present embodiment, the temperature inside the camera body 130 rises due to heat generation of the power unit 121 attributed to the charging processing in the shutdown state. A time period required for the temperature inside the camera body 130 to decrease to the actual ambient temperature TO after the outer casing temperature T2 has been determined to be higher than the outer casing temperature threshold T2th in step S106 and the digital camera 100 has been placed in the shutdown state, is longer in a case where the power unit 121 is charged in the shutdown state than in a case where the power unit 121 is not charged in the shutdown state. For this reason, in a case where the power unit 121 has been charged during the shutdown and the digital camera 100 has been placed in the power ON state before the temperature inside the camera body 130 decreases to the actual ambient temperature TO, the first temperature T1 detected by the first thermometer 111 is influenced by the temperature inside the camera body 130, and becomes high compared to a case where the power unit 121 has not been charged. Accordingly, the estimated ambient temperature Tout, which is set based on the first temperature T1, becomes high as well. Therefore, the cooling time period CP2 is set based on a time period required for the temperature inside the camera body 130 to decrease to the actual ambient temperature TO in a case where the power unit 121 has been charged during the shutdown. The cooling time period CP2 is obtained in advance through an experiment or the like; a plurality of different values are prepared thereas for different temperature differences ΔT, and the cooling time period CP2 is set at a value corresponding to a range to which the temperature difference ΔT belongs. The cooling time period CP2 varies with each apparatus; for example, when the temperature difference ΔT is 2° C., the cooling time period CP2 is set at 60 minutes.

In step S208, the control unit 101 reads out the time information P2 obtained in step S124 of FIG. 4B from the nonvolatile memory 116.

In step S209, the control unit 101 calculates an elapsed time period ΔP2 (CL−P2) after the charging has been stopped by obtaining current time information CL from the timer unit 123 and subtracting the time information P2 obtained in step S208 from the current time information CL, and stores the same into the working memory 117.

In step S210, the control unit 101 compares the cooling time period CP2 set in step S207 with the elapsed time period ΔP2 after the charging has been stopped, which has been calculated in step S209 and determines whether the cooling time period CP2 is longer than the elapsed time period ΔP2. When the control unit 101 has determined that the elapsed time period ΔP2 after the charging has been stopped, which has been calculated in step S209, is not longer than the cooling time period CP2 set in step S207, it determines that the temperature inside the camera body 130 has not sufficiently decreased approximately to the actual ambient temperature TO, and the control unit 101 proceeds the processing to step S211. When the control unit 101 has determined that the elapsed time period ΔP2 after the charging has been stopped, which has been calculated in step S209, is longer than the cooling time period CP2 set in step S207, it determines that the temperature inside the camera body 130 has sufficiently decreased approximately to the actual ambient temperature TO, and the control unit 101 proceeds the processing to step S212.

In step S211, the control unit 101 calculates an estimated ambient temperature Tout at the time of reactivation and stores the same into the nonvolatile memory 116, and the control unit 101 proceeds the processing to step S102 of FIG. 3. The control unit 101 calculates the estimated ambient temperature Tout at the time of reactivation by subtracting a correction value α that is set based on the elapsed time period ΔP2 after the charging has been stopped, which has been calculated in step S209, from the interim ambient temperature T1on at the time of reactivation, which has been obtained in step S201. The correction value α is obtained in advance through an experiment or the like; a plurality of different values are prepared thereas for different time differences between the elapsed time period ΔP2 and the cooling time period CP2, and the correction value α is set at a value corresponding to a range to which the time difference belongs. The time difference varies with each apparatus; for example, when the time difference is smaller than 30 minutes, the correction value α is set at −3° C. Also, when the time difference is equal to or larger than 30 minutes, the correction value α is set at −5° C.

In step S212, the control unit 101 sets the interim ambient temperature T1on at the time of reactivation, which has been obtained in step S201, as the estimated ambient temperature Tout and stores the same into the nonvolatile memory 116, and the control unit 101 proceeds the processing to step S102 of FIG. 3.

FIG. 6 is a flowchart showing the control processing for a case where the charging processing for the power unit 121 has not been executed during the shutdown state of the digital camera 100, the power has been switched from OFF to ON, and the digital camera 100 has been activated.

In step S301, the control unit 101 obtains the first temperature T1 from the first thermometer 111, and stores the same into the working memory 117 as an interim ambient temperature T1on at the time of reactivation.

In step S302, the control unit 101 reads out the ambient temperature T1off immediately before the stop processing, which has been obtained in step S108 of FIG. 4A, from the nonvolatile memory 116.

In step S303, the control unit 101 reads out the estimated ambient temperature Tout_pre immediately before the stop processing, which has been obtained in step S109 of FIG. 4A, from the nonvolatile memory 116.

In step S304, the control unit 101 calculates a temperature difference ΔT between T1off and Tout_pre obtained in steps S302 and S303 (T1off−Tout_pre), and stores the same into the working memory 117.

In step S305, the control unit 101 sets a cooling time period CP1 until a decrease to the actual ambient temperature TO is achieved in accordance with the temperature difference ΔT calculated in step S304, and stores the same into the working memory 117. Here, the charging processing for the power unit 121 has not been executed during the shutdown. The temperature inside the camera body 130 rises due to heat generation of the heat source devices immediately before entering the shutdown state as a result of determining that the outer casing temperature T2 is higher than the outer casing temperature threshold T2th in step S106. A time period required for the temperature inside the camera body 130 to decrease to the actual ambient temperature TO during the shutdown is shorter in a case where the power unit 121 is not charged than in a case where the power unit 121 is charged. However, even in a case where the power unit 121 is not charged during the shutdown, when the digital camera 100 has been reactivated before the temperature inside the camera body 130 decreases to the actual ambient temperature TO, the first temperature T1 detected by the first thermometer 111 rises under the influence of the temperature inside the camera body 130, thereby making the estimated ambient temperature Tout, which is set based on the first temperature T1, high as well. Therefore, the cooling time period CP1 (<CP2) is set at a time period required for the temperature inside the camera body 130 to decrease to the actual ambient temperature TO in a case where the power unit 121 is not charged during a shutdown attributed to a restriction of operations. The cooling time period CP1 is obtained in advance through an experiment or the like; a plurality of different values are prepared for different temperature differences ΔT, and the cooling time period CP1 is set at a value corresponding to a range to which the temperature difference ΔT belongs. The cooling time period CP1 varies with each apparatus; for example, when the temperature difference ΔT is 7° C., the cooling time period CP2 is set at 90 minutes.

In step S306, the control unit 101 reads out the time information P1 obtained in step S110 of FIG. 4A from the nonvolatile memory 116.

In step S307, the control unit 101 calculates an elapsed time period ΔP1 (CL-P1) after the stop processing by obtaining current time information CL from the timer unit 123 and subtracting the time information P1 obtained in step S306 from the current time information CL, and stores the same into the working memory 117.

In step S308, the control unit 101 compares the cooling time period CP1 set in step S305 with the elapsed time period ΔP1 after the stop processing, which has been calculated in step S307 and determines whether the elapsed time period ΔP1 is longer than the cooling time period CP1. When the control unit 101 has determined that the elapsed time period ΔP1 after the stop processing, which has been calculated in step S307, is not longer than the cooling time period CP1 set in step S305, it determines that the temperature inside the camera body 130 has not sufficiently decreased approximately to the actual ambient temperature TO, and the control unit 101 proceeds the processing to step S309. When the control unit 101 has determined that the elapsed time period ΔP1 after the stop processing, which has been calculated in step S307, is longer than the cooling time period CP1 set in step S305, it determines that the temperature inside the camera body 130 has sufficiently decreased approximately to the actual ambient temperature TO, and the control unit 101 proceeds the processing to step S310.

In step S309, the control unit 101 calculates an estimated ambient temperature Tout at the time of reactivation and stores the same into the nonvolatile memory 116, and the control unit 101 proceeds the processing to step S102 of FIG. 3. The control unit 101 calculates the estimated ambient temperature Tout by subtracting a correction value β that is set based on the elapsed time period ΔP1 after the stop processing, which has been calculated in step S307, from the interim ambient temperature T1on at the time of reactivation, which has been obtained in step S301. The correction value β (<α) is obtained in advance through an experiment or the like; a plurality of different values are prepared thereas for different time differences between the elapsed time period ΔP1 and the cooling time period CP1, and the correction value β is set at a value corresponding to a range to which the time difference belongs. The time difference varies with each apparatus; for example, when the time difference is smaller than 30 minutes, the correction value β is set at −3° C. Also, when the time difference is equal to or larger than 30 minutes, the correction value β is set at −5° C.

In step S310, the control unit 101 sets the interim ambient temperature T1on at the time of reactivation, which has been obtained in step S301, as the estimated ambient temperature Tout, and stores the same into the nonvolatile memory 116, and the control unit 101 proceeds the processing to step S103 of FIG. 3.

As described above, according to the present embodiment, the estimated ambient temperature Tout is calculated in consideration of an increase in the temperature inside the camera body 130 caused by heat generation of the heat source devices before the stop processing, and also by heat generation of the power unit 121 for which the charging processing has been executed during a shutdown attributed to a restriction of operations, and the state of heat dissipation inside the camera body 130 until the time of reactivation; consequently, the accuracy of the estimated ambient temperature Tout can be improved using a method that is simpler than conventional methods, and an appropriate temperature can be set as the outer casing temperature threshold T2th for restricting the operations of the digital camera 100.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-042318, filed Mar. 16, 2023 which is hereby incorporated by reference herein in its entirety.

What is claimed is:

1. An electronic apparatus comprising:
a first thermometer that detects a first temperature corresponding to an ambient temperature of an environment in which the electronic apparatus is used;
a second thermometer that detects a second temperature corresponding to a temperature of an outer casing of the electronic apparatus;
a processor; and
a memory storing a program that, when executed by the processor, causes the electronic apparatus to function as:
a charging unit that executes charging processing for charging a battery; and
a control unit that performs control to obtain an estimated ambient temperature by estimating an ambient temperature based on the first temperature, and restrict an operation of the electronic apparatus when the second temperature has reached a threshold that has been set based on the estimated ambient temperature,
wherein the control unit obtains the estimated ambient temperature using a first method when the charging processing has been executed in a state where the electronic apparatus is not activated, and obtains the estimated ambient temperature using a second method when the charging processing has not been executed in the state where the electronic apparatus is not activated.

2. The electronic apparatus according to claim 1, wherein
the control unit obtains the estimated ambient temperature using the first method when a length of a time period of the charging processing exceeds a threshold based on a length of a time period in which the charging processing has been executed in the state where the electronic apparatus is not activated.

3. The electronic apparatus according to claim 1, wherein
in a case where the estimated ambient temperature is obtained using the first method, the control unit obtains a cooling time period based on the first temperature and the estimated ambient temperature immediately before entering the state where the electronic apparatus is not activated, and obtains the estimated ambient temperature based on the cooling time period and on an elapsed time period after the charging processing has been stopped, the cooling time period being required for a temperature inside the electronic apparatus to decrease to the ambient temperature.

4. The electronic apparatus according to claim 3, wherein
when the elapsed time period is longer than the cooling time period, the control unit sets the first temperature detected by the first thermometer after entering a state where the electronic apparatus is activated as the estimated value, and when the elapsed time period is not longer than the cooling time period, the control unit sets a temperature obtained by correcting the first temperature after entering the state where the electronic apparatus is activated in accordance with the elapsed time period as the estimated ambient temperature.

5. The electronic apparatus according to claim 1, wherein
in a case where the estimated ambient temperature is obtained using the second method, the control unit obtains a cooling time period based on the first temperature and the estimated ambient temperature immediately before entering the state where the electronic apparatus is not activated, sets the first temperature after the electronic apparatus has been activated as the estimated ambient temperature when an elapsed time period after entering the state where the electronic apparatus is not activated is longer than the cooling time period, and sets a temperature obtained by correcting the first temperature detected after the electronic apparatus has been activated in accordance with the elapsed time period as the estimated ambient temperature when the elapsed time period is not longer than the cooling time period, the cooling time period being required for a temperature inside the electronic apparatus to decrease to the ambient temperature.

6. The electronic apparatus according to claim 1, wherein
the state where the electronic apparatus is not activated includes a power-OFF state or a state where a power supply to a heat source device in the electronic apparatus has been stopped.

7. The electronic apparatus according to claim 1, wherein
the control unit obtains the estimated ambient temperature and sets the threshold based on the obtained estimated ambient temperature when the state where the electronic apparatus is not activated has been switched to a state where the electronic apparatus is activated, and performs the control to restrict the operation of the electronic apparatus when the second temperature has reached the threshold after entering the state where the electronic apparatus is activated.

8. The electronic apparatus according to claim 1, wherein
in a state where the electronic apparatus is activated, the control unit notifies a user of an operable time period of the electronic apparatus until the second temperature reaches the threshold.

9. The electronic apparatus according to claim 1, further comprising:
a heat source device arranged inside a housing of the electronic apparatus,
wherein the first thermometer is placed at a position that is distanced from the heat source device by a predetermined distance, and the second thermometer is placed so that there is a correlation between a temperature of a position that exhibits the highest temperature due to heat generation of the heat source device out of a section in which a user touches the electronic apparatus to hold the electronic apparatus and the second temperature.

10. The electronic apparatus according to claim 9, wherein
the processor functions as the heat source device.

11. The electronic apparatus according to claim 1, wherein
the electronic apparatus is a hand-held electronic apparatus.

12. The electronic apparatus according to claim 1, wherein
the charging unit charges the battery using power supplied from an external apparatus when the external apparatus is connected to the electronic apparatus.

13. The electronic apparatus according to claim 1, wherein
the battery is used as a power source for the electronic apparatus.

14. A control method for an electronic apparatus,
wherein the electronic apparatus comprises:
a first thermometer that detects a first temperature corresponding to an ambient temperature of an environment in which the electronic apparatus is used;
a second thermometer that detects a second temperature corresponding to a temperature of an outer casing of the electronic apparatus; and
a charging unit that executes charging processing for charging a battery,
wherein the control method comprises:
performing control to obtain an estimated ambient temperature by estimating an ambient temperature based on the first temperature, and restrict an operation of the electronic apparatus when the second temperature has reached a threshold that has been set based on the estimated ambient temperature,
in the controlling, the estimated ambient temperature is obtained using a first method when the charging processing has been executed in a state where the electronic apparatus is not activated, and the estimated ambient temperature is obtained using a second method when the charging processing has not been executed in the state where the electronic apparatus is not activated.

15. A non-transitory computer-readable storage medium storing a program for causing a computer to function as an electronic apparatus comprising:
a first thermometer that detects a first temperature corresponding to an ambient temperature of an environment in which the electronic apparatus is used;
a second thermometer that detects a second temperature corresponding to a temperature of an outer casing of the electronic apparatus;
a processor; and
a memory storing a program that, when executed by the CPU, causes the electronic apparatus to function as:
a charging unit that executes charging processing for charging a battery; and
a control unit that performs control to obtain an estimated ambient temperature by estimating an ambient temperature based on the first temperature, and restrict an operation of the electronic apparatus when the second temperature has reached a threshold that has been set based on the estimated ambient temperature,
wherein the control unit obtains the estimated ambient temperature using a first method when the charging processing has been executed in a state where the electronic apparatus is not activated, and obtains the estimated ambient temperature using a second method when the charging processing has not been executed in the state where the electronic apparatus is not activated.
